(19) United States
(12) Patent Application Publication
(10) Pub. No.: US 2013/0317925 A1
(43) Pub. Date: Nov. 28, 2013

(54) Transaction Auto Synchronization

(71) Applicant: Lucy M. Zhao, Austin, TX (US)

(72) Inventor: Lucy M. Zhao, Austin, TX (US)

(73) Assignee: eBay, Inc., San Jose, CA (US)

(21) Appl. No.: 13/478,554

(22) Filed: May 23, 2012

(51) Int. Cl. G06Q 30/00; H04W 4/00; G06Q 20/20

(52) U.S. Cl. 705/21; 705/26.61

(57) ABSTRACT

A system according to an embodiment comprises one or more processors; and one or more memories adapted to store a plurality of machine-readable instructions which when executed by the processor(s) are adapted to cause the system to: receive online search information in connection with one or more desired items from a user device of a user, wherein the user device includes an application loaded in the user device from a server at a remote location; auto-synchronize the online search information to a mobile device of the user; and send an alert via the mobile device when the mobile device is in a proximity of a point of sale location of the one or more desired items associated with the online search information.

### BACKGROUND

1. Technical Field

Embodiments of the present disclosure generally relate to transactions, and more particularly, to methods and systems for auto synchronization of transactions.

2. Related Art

In electronic commerce, a customer routinely searches for, purchases and pays for products and/or services from online merchants over communication networks, such as the Internet. In this regard, individual customers may frequently engage in transactions with a variety of merchants through, for example, various merchant websites. Routinely, customers engage in such transactions by using their mobile device. However, typical ways of conducting transactions over the Internet may be cumbersome and inconvenient. For example, when searching for a product over the Internet, the customer does not get the experience of personally seeing or trying out the product that the customer is potentially interested in purchasing. Accordingly, there is a need for a more convenient way of conducting transactions.

### SUMMARY

As will be further described herein in relation to various embodiments, methods and systems are provided for auto synchronization of transactions.

In accordance with an embodiment of the disclosure, a system comprises one or more processors; and one or more memories adapted to store a plurality of machine-readable instructions which when executed by the processor(s) are adapted to cause the system to: receive online search information in connection with one or more desired items from a user device of a user, wherein the user device includes an application loaded in the user device from a server at a remote location; auto-synchronize the online search information to a mobile device of the user; and send an alert via the mobile device when the mobile device is in a proximity of a point of sale location of the one or more desired items associated with the online search information.

In accordance with another embodiment of the disclosure, a method comprises: receiving, electronically by a processor, online search information in connection with one or more desired items from a user device of a user, wherein the user device includes an application loaded in the user device from a server at a remote location. The method also comprises auto-synchronizing, electronically by the processor, the online search information to a mobile device of the user. And the method further comprises sending, electronically by the processor, an alert via the mobile device when the mobile device is in a proximity of a point of sale location of the one or more desired items associated with the online search information.

In accordance with another embodiment of the disclosure, a computer readable medium comprises a non-transitory computer readable medium on which are stored computer readable instructions and, when executed by a processor, cause the processor to: receive online search information in connection with one or more desired items from a user device of a user, wherein the user device includes an application loaded in the user device from a server at a remote location; auto-synchronize the online search information to a mobile device of the user; and send an alert via the mobile device when the mobile device is in a proximity of a point of sale location of the one or more desired items associated with the online search information.

These and other features and advantages of the embodiments of the present disclosure will be more readily apparent from the detailed description of the embodiments set forth below taken in conjunction with the accompanying drawings.

### BRIEF DESCRIPTION OF THE FIGURES

FIG. 1 is a block diagram illustrating a system for transaction auto synchronization according to an embodiment of the present disclosure.

FIG. 2 is a flow diagram illustrating a method for transaction auto synchronization according to an embodiment of the present disclosure.

FIG. 3 is a block diagram of a system for implementing a device according to one embodiment of the present disclosure.

Like element numbers in different figures represent the same or similar elements.

### DETAILED DESCRIPTION

In accordance with various embodiments described herein, methods and systems are provided for auto-synchronization of transactions. In an embodiment, an application may be loaded on one or more user devices of a user or customer by a server at a remote location such as a service provider server. When the user or customer is searching for products or services (“items”) online over a network via a user device (e.g., a mobile device or any other user device such as a personal computer also having the downloaded application), the details of the search may be auto-synchronized to the user's mobile device. The application, which may be loaded on the mobile device, enables the mobile device to send alerts when the user is near a point of sale of one or more of the items in the search so that the user may go and physically see or try out the items in person and potentially purchase the items. It should be noted that auto-synchronization as used in one or more embodiments herein may refer to a user searching online on a first user device wherein search details may be synchronized to a separate second user device, or to the first user device itself.

The application may be provided by a service provider such as PayPal® and/or eBay®, Inc. of San Jose, Calif.

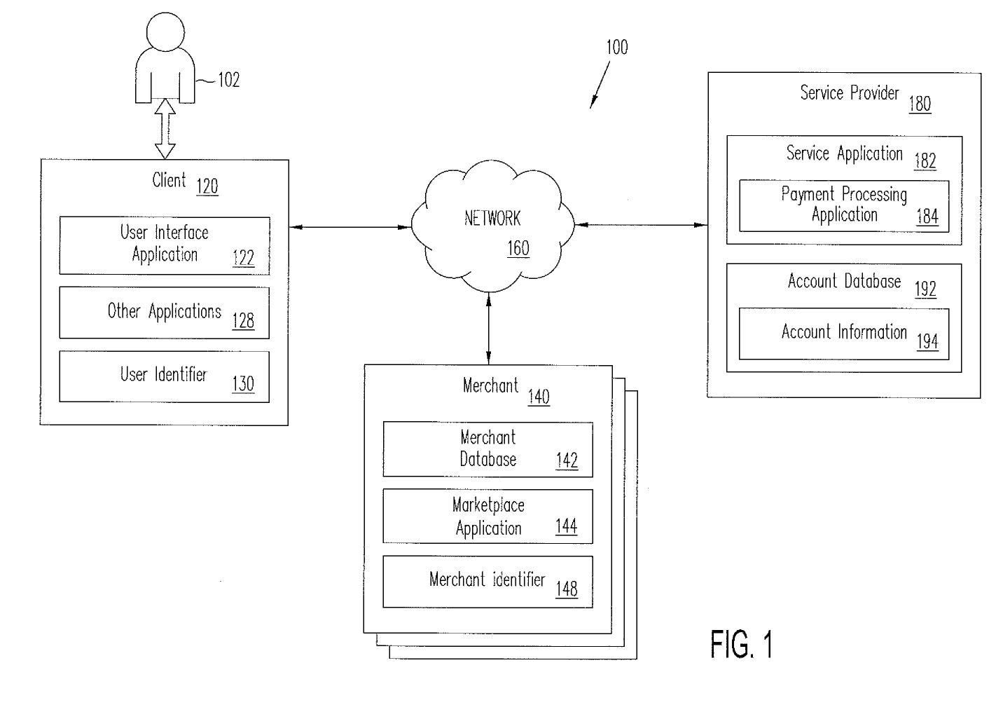

Referring now to the drawings wherein the showings are for purposes of illustrating embodiments of the present disclosure only, and not for purposes of limiting the same, FIG. 1 illustrates a block diagram of a system for transaction auto-synchronization according to an embodiment of the present disclosure.

FIG. 1 shows one embodiment of a block diagram of a system 100 adapted to facilitate transaction auto-synchronization using a client device 120 over a network 160. As shown in FIG. 1, the system 100 includes at least one client device 120 (e.g., network computing device), one or more merchant servers or devices 140 (e.g., network server devices), and at least one service provider server or device 180 (e.g., network server device) in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the client device 120, merchant servers or devices 140, and service provider server or device 180 may be associated with a particular link (e.g., a link, such as a URL (Uniform Resource Locator) to an IP (Internet Protocol) address).

The client device 120, in various embodiments, may be implemented using any appropriate combination of hardware and/or software configured for wired and/or wireless communication over the network 160. In various examples, the client device 120 may be implemented as a wireless telephone (e.g., cellular or mobile phone), a tablet, a personal digital assistant (PDA), a personal computer, a notebook computer, and/or various other generally known types of wired and/or wireless computing devices. It should be appreciated that the client device 120 may be referred to as a user device or a customer device without departing from the scope of the present disclosure.

The client device 120, in one embodiment, includes a user interface application 122, which may be utilized by the user 102 to conduct transactions (e.g., shopping, purchasing, bidding, etc.) with the merchant server or device 140 or with the service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. In another example, the user 102 is able to access merchant websites via the one or more merchant servers 140 to view and select applications, products, and/or services (“items”) for purchase, and the user 102 is able to purchase items from the one or more merchant servers 140 via the service provider server 180. Accordingly, in one or more embodiments, the user 102 may conduct transactions (e.g., purchase and provide payment for one or more items) from the one or more merchant servers 140 via the service provider server 180.

The client device 120, in various embodiments, may include other applications 128 as may be desired in one or more embodiments of the present disclosure to provide additional features available to the user 102. In one example, such other applications 128 may include security applications for implementing client-side security features, programmatic client applications for interfacing with appropriate application programming interfaces (APIs) over the network 160, and/or various other types of generally known programs and/or software applications. In still other examples, the other applications 128 may interface with the user interface application 122 for improved efficiency and convenience.

According to one or more embodiments, the user interface application 122 or the other applications 128 include an application that may be loaded on client device 120 by a server at a remote location such as service provider server 180. The application enables a user device (which may be user device 120 or a separate user device such as a personal computer also having the downloaded application) to auto-synchronize details of a search for items over a network to user device 120. The application on user device 120 may then send alerts when user 102 is near or in a proximity of a point of sale location of the items searched, for example when the user is in front of a venue of a point of sale or within a hotspot WiFi or Bluetooth range. “Near” or “in a proximity” may be defined by the system, the remote location, the merchant, and/or the user. For example, the system may determine that the user is near a location of the items searched when the user gets within a certain area or distance, e.g., within one mile, 500 yards, etc., of a merchant. The area or distance may vary depending on location, such as if the user is in a densely populated shopping area like a mall or in a rural location where stores are spaced far apart. User 102 may then decide to see or try out the items in person and potentially purchase the items. As such, auto-synchronization may be used with location-based services. In one or more embodiments, user 102 may complete a transaction such as purchasing the items via service provider server 180.

In one embodiment, a user may conduct an online search for certain items on a first user device such as a home or office desktop or personal computer having the downloaded application. In that case, the search details may be synchronized to a second user device such as a mobile device also having the downloaded application. In another embodiment, the user may conduct a search for certain items on the user's mobile device itself, and the auto-synchronization may occur at a later time. As such, in embodiments of the present disclosure, the search details may be “remembered” at some point in time such that when the user is near a physical location of the searched items, the user device (e.g. mobile device) may alert the user so he or she may decide to see or try out and potentially purchase the searched items at the physical location. It should be noted that auto-synchronization as used in one or more embodiments herein may refer to a user searching online on a first user device wherein search details may be synchronized to a separate second user device, or to the first user device itself.

In various embodiments, a variety of implementations for auto-synchronization with location based services may be used. In one example, the search details may be stored, e.g., in the cloud, along with GPS positions of physical retail locations of the searched items, which may then be compared against the GPS location of the user's GPS enabled mobile device. An alert may be sent when an item is in a near physical location.

The client device 120, in one embodiment, may include at least one user identifier 130, which may be implemented, for example, as operating system registry entries, cookies associated with the user interface application 122, identifiers associated with hardware of the client device 120, or various other appropriate identifiers. The user identifier 130 may include one or more attributes related to the user 102, such as personal information related to the user 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 130 may be passed with a user login request to the service provider server 180 via the network 160, and the user identifier 130 may be used by the service provider server 180 to associate the user 102 with a particular user account maintained by the service provider server 180.

The one or more merchant servers 140, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering the items to the user 102 over the network 160. As such, each of the one or more merchant servers 140 may include a merchant database 142 for identifying available items, which may be made available to the client device 120 for viewing and purchase by the user 102. It should be appreciated that although a user-merchant transaction is illustrated in this embodiment, the system may also be applicable to user-user, merchant-merchant and/or merchant-user transactions.

Each of the merchant servers 140, in one embodiment, may include a marketplace application 144, which may be configured to provide info nation over the network 160 to the user interface application 122 of the client device 120. For example, the user 102 may interact with the marketplace application 144 through the user interface application 122 over the network 160 to search and view various items available for purchase in the merchant database 142.

Each of the merchant servers 140, in one embodiment, may include at least one merchant identifier 148, which may be included as part of the one or more items made available for purchase so that, e.g., particular items are associated with particular merchants. In one implementation, the merchant identifier 148 may include one or more attributes and/or parameters related to the merchant, such as business and banking information. In various embodiments, user 102 may conduct transactions (e.g., searching, selection, monitoring, purchasing, and/or providing payment for items) with each merchant server 140 via the service provider server 180 over the network 160.

The service provider server 180, in one embodiment, may be maintained by a transaction processing entity, which may provide processing for financial transactions and/or information transactions between the user 102 and one or more of the merchant servers 140.

As such, the service provider server 180 includes a service application 182, which may be adapted to interact with each client device 120 and/or each merchant server 140 over the network 160 to facilitate the searching, selection, purchase, and/or payment of items by the user 102 from one or more of the merchant servers 140. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing module 184 to process purchases and/or payments for financial transactions between the user 102 and each of the merchant servers 140. In one implementation, the payment processing module 184 assists with resolving financial transactions through validation, delivery, and settlement. As such, the service application 182 in conjunction with the payment processing module 184 settles indebtedness between the user 102 and each of the merchants 140, wherein accounts may be directly and/or automatically debited and/or credited of monetary funds in a manner as accepted by the banking industry.

The service provider server 180, in one embodiment, may be configured to maintain one or more user accounts and merchant accounts in an account database 192, each of which may include account information 194 associated with one or more individual users (e.g., user 102) and merchants (e.g., one or more merchants associated with merchant servers 140). For example, account information 194 may include private financial information of each user 102 and each merchant associated with the one or more merchant servers 140, such as one or more account numbers, passwords, credit card information, banking information, or other types of financial information, which may be used to facilitate financial transactions between the user 102 and the one or more merchants associated with the merchant servers 140. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and the user 102 may have credentials to authenticate or verify identity with the service provider server 180. User attributes may include personal information, banking information and/or funding sources as previously described. In various aspects, the user attributes may be passed to the service provider server 180 as part of a login, search, selection, purchase, and/or payment request, and the user attributes may be utilized by the service provider server 180 to associate the user 102 with one or more particular user accounts maintained by the service provider server 180.

The system described above with respect to the embodiment of FIG. 1 may be used for transaction auto synchronization such that when a user searches for one or more items online, for example on one or more websites hosted by merchant servers 140, the details of the search are auto synchronized to a mobile device of the user. When the user is in a proximity of a point of sale for the searched items, for example when the user is right outside or in front of a point of sale venue or within a hotspot WiFi or Bluetooth range, the mobile device sends an alert so the user may see, inspect or try out the items in person at the point of sale location.

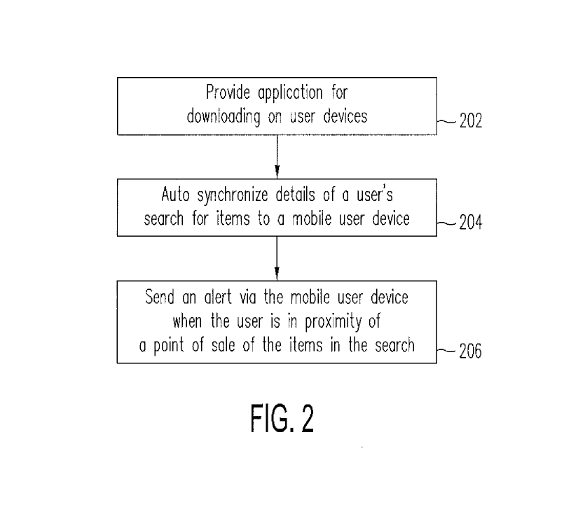

Referring now to FIG. 2, a flow diagram of a method for transaction auto-synchronization is illustrated according to an embodiment of the present disclosure. It should be appreciated that the method illustrated in the embodiment of FIG. 2 may be implemented by the system illustrated in FIG. 1 according to one or more embodiments.

In block 202, an application may be provided for installing or downloading and running on one or more user devices. The application may be provided by a server in a remote location such as a payment service provider server. The application may be installed on any one or more user devices associated with a user such as a personal computer or a tablet, as well as on a mobile user device as described above.

In an embodiment, a customer or user may browse a website hosted by a merchant server and search online for one or more particular items. For example, the user may search for particular desired items online using his or her personal computer, tablet, mobile device or any other user device having the downloaded application. A desired item may be one that the user specifically searches for, such as by entering a specific search term or item description, one that the user places in a cart but does not purchase, one that the user requests details on such as accessing a URL or site describing the item, or other indicators of interest. Even though many items meeting the desired search criteria may be found via the online search, the user may wish to experience or try out an item in person. For example, a customer may search online for a particular brand of tennis rackets. Even though many tennis rackets meeting the search criteria such as the specific brand are found, the customer may be interested in trying out the tennis rackets in person to see how they feel in his or her hand.

In block 204, the details of the user's search for one or more particular items are auto synchronized to a mobile user device having the downloaded application. It should be noted that in an embodiment where the user searches for items online, for example using a personal computer, the details of the search may be auto synchronized to the user's mobile device as the application may be installed both on the personal computer and the mobile device. In other embodiments, the online search may be conducted on the mobile device itself, and the auto-synchronization may occur at a later time. In an example, the user may conduct an online search for a specific item using his or her mobile phone at any time, for example, while riding a bus. When the user gets off the bus and walks a few blocks, the mobile device may alert the user that the specific item for which he or she searched earlier in the bus is located in a store around the corner.

In one or more embodiments of the present disclosure, the search details may be “remembered” for some period of time or for a certain number of searches. For example, the system may save search details for the previous month, for the previous ten searches, for the previous 20 items, etc. In this regard, the search details may be auto-synchronized to the user's mobile device such that the auto synchronization may be used with location-based services, e.g., as used in GPS enabled user devices, so that “relevant” or recent searches may be “remembered.”

In block 206, an alert is sent via the mobile user device when the user is in proximity of a point of sale of the items in the search. The user may decide to enter the point of sale location to personally see or try out one or more items in the search and potentially purchase the item(s). For example, the customer having searched for a particular brand of tennis rackets may eventually walk by a sports store that carries the particular brand of tennis rackets. At that time, the customer may be alerted or prompted, for example, by a text message, on his or her mobile device, that the particular brand of tennis rackets on her online search is available at that sports store. It should be noted that there are many ways in which the customer may be alerted or prompted on his or her mobile device, for example, by a text message, an email, an audible sound, a vibration mode, a flashing or pop-up message, and/or any other suitable manner. The customer may then walk into the sports store and try out the tennis rackets and potentially decide to purchase a racket.

In one or more embodiments, the customer may decide to complete the transaction such as make payment via his or her account with a service provider (e.g., service provider server 180 of FIG. 1). In that regard, user 102 (referring to FIG. 1) may have a pre-existing account with service provider server 180 wherein user 102 has identity attributes stored with service provider server 180 as described above. Once user 102 decides to purchase and pay for the selected item, service provider server 180 may be used to effect the payment. In other embodiments, user 102 may choose cash or a specific transaction card as a funding source to complete payment and finalize the transaction.

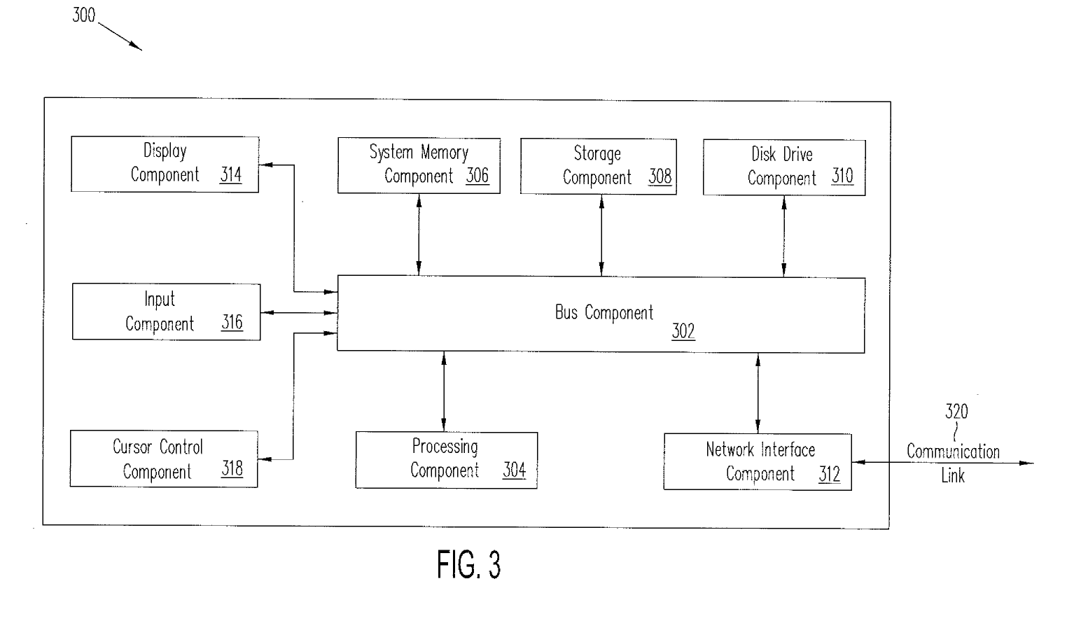

Referring now to FIG. 3, a block diagram of a system 300 is illustrated suitable for implementing embodiments of the present disclosure, including client device 120, one or more merchant servers or devices 140, and service provider server or device 180. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 30S (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to search according to desired item criteria, auto synchronize search details and use with location-based services, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 160 of FIG. 1, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods and systems have been described according to one or more embodiments for auto synchronization of transactions (used with location-based services).

Although various components and steps have been described herein as being associated with client device 120, merchant server 140, and payment service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. For example, although merchant transactions have been described according to one or more embodiments, it should be understood that the present disclosure may also apply to transactions where requests for information, requests for access, or requests to perform certain other transactions may be involved.

Having thus described embodiments of the disclosure, persons of ordinary skill in the art will recognize that changes may be made in form and detail without departing from the scope of the disclosure. Thus the disclosure is limited only by the claims.

What is claimed is:

1. A system comprising:
one or more processors; and
one or more memories in communication with the one or more processors and adapted to store a plurality of machine-readable instructions which when executed by the one or more processors are adapted to cause the system to:
receive online search information in connection with one or more desired items from a user device of a user, wherein the user device includes an application loaded in the user device from a server at a remote location;
auto-synchronize the online search information to a mobile device of the user; and
send an alert via the mobile device when the mobile device is in a proximity of a point of sale location of the one or more desired items associated with the online search information.

2. The system of claim 1, wherein the plurality of machine-readable instructions are adapted to further cause the system to complete a transaction associated with the one or more desired items at the point of sale location.

3. The system of claim 1, wherein the plurality of machine-readable instructions are adapted to further cause the system to complete a transaction associated with the one or more desired items via the server at the remote location.

4. The system of claim 1, wherein the user device and the mobile device are separate devices, and each device comprises the loaded application from the server at the remote location.

5. The system of claim 1, wherein the user device and the mobile device are the Same.

6. The system of claim 5, wherein the plurality of machine-readable instructions are adapted to further cause the system to:
receive the online search information in connection with the one or more desired items from the mobile device, wherein the mobile device includes the application loaded from the server at the remote location; and
auto-synchronize the online search information to the mobile device at a later time.

7. The system of claim 1, wherein the proximity of the point of sale location further comprises a location near a venue of the point of sale location and/or within a hotspot WiFi or Bluetooth range.

8. The system of claim 1, wherein the plurality of machine-readable instructions are adapted to further cause the system to save the search information in connection with the one or more desired items for a predetermined period of time.

9. The system of claim 8, wherein the period of time is based, at least in part, on how long ago the one or more desired items was last searched and/or a number of searches conducted since the one or more items was last searched.

10. A method comprising:
receiving, electronically by a processor, online search information in connection with one or more desired items from a user device of a user, wherein the user device includes an application loaded in the user device from a server at a remote location;
auto-synchronizing, electronically by the processor, the online search information to a mobile device of the user; and
sending, electronically by the processor, an alert via the mobile device when the mobile device is in a proximity of a point of sale location of the one or more desired items associated with the online search information.

11. The method of claim 10, further comprising completing a transaction associated with the one or more desired items at the point of sale location.

12. The method of claim 10, further comprising completing a transaction associated with the one or more desired items via the server at the remote location.

13. The method of claim 10, wherein the user device and the mobile device are separate devices, and each device comprises the loaded application from the server at the remote location.

14. The method of claim 10, wherein the user device and the mobile device are the same.

15. The method of claim 14, further comprising:
receiving the online search information in connection with the one or more desired items from the mobile device, wherein the mobile device includes the application loaded from the server at the remote location; and
auto-synchronizing the online search information to the mobile device at a later time.

16. The method of claim 10, further comprising saving the search information in connection with the one or more desired items for a predetermined period of time.

17. The method of claim 16, further comprising basing the period of time, at least in part, on how long ago the one or more desired items was last searched and/or a number of searches conducted since the one or more items was last searched.

18. A non-transitory computer readable medium on which are stored computer readable instructions and, when executed by a processor, cause the processor to:
receive online search information in connection with one or more desired items from a user device of a user, wherein the user device includes an application loaded in the user device from a server at a remote location;
auto-synchronize the online search information to a mobile device of the user; and
send an alert via the mobile device when the mobile device is in a proximity of a point of sale location of the one or more desired items associated with the online search information.

19. The medium of claim 18, wherein the computer readable instructions further cause the processor to complete a transaction associated with the one or more desired items at the point of sale location.

20. The medium of claim 18, wherein the computer readable instructions further cause the processor to complete a transaction associated with the one or more desired items via the server at the remote location.

21. The medium of claim 18, wherein the user device and the mobile device are separate devices, and each device comprises the loaded application from the server at the remote location.

22. The medium of claim 18, wherein the user device and the mobile device are the same.

23. The medium of claim 18, wherein the computer readable instructions further cause the processor to save the search information in connection with the one or more desired items for a predetermined period of time.

24. The medium of claim 23, wherein the period of time is based, at least in part, on how long ago the one or more desired items was last searched and/or a number of searches conducted since the one or more items was last searched.
